(19) United States
(12) Patent Application Publication
(10) Pub. No.: US 2012/0092144 A1
(43) Pub. Date: Apr. 19, 2012

(54) ELECTRONIC DEVICE, CONTROL DEVICE AND CONTROL METHOD THEREOF

(75) Inventor: Hyo-dae KIM, Yongin-si (KR)

(73) Assignee: SAMSUNG ELECTRONICS CO., LTD., Suwon-si (KR)

(21) Appl. No.: 13/151,913

(22) Filed: Jun. 2, 2011

(30) Foreign Application Priority Data
Oct. 13, 2010 (KR) 10-2010-0099692

(51) Int. Cl. G08C 19/12

(52) U.S. Cl. 340/13.24

(57) ABSTRACT

An electronic device, a device for controlling the electronic device, and a control method for controlling the electronic device are provided. The electronic device including: a first communication unit which is connected to, and communicates with, another electronic device; a second communication unit which communicates with a control device used to input a user command; and a controller which pairs with the control device for communication, the controller performs an operation based on the user command received from the control device; receives control device information from the control device; transmits the control device information to an other electronic device; receives electronic device information from an other electronic device, and transmits the electronic device information to the control device for communication between the control device and an other electronic device. With this configuration, users may pair and use network devices without difficulty.

### CROSS-REFERENCE TO RELATED APPLICATION

This application claims priority from Korean Patent Application No. 10-2010-0099692, filed on Oct. 13, 2010 in the Korean Intellectual Property Office, the disclosure of which is incorporated herein by reference.

### BACKGROUND

1. Field

Apparatuses and methods consistent with the exemplary embodiments relate to an electronic device, a control device and a control method thereof. More particularly, the exemplary embodiments relate to an electronic device, a control device and a control method thereof which has a network function.

2. Description of the Related Art

As an electronic device which is connected to a network, a display apparatus, a remote controller, an image device, etc. may recognize one another according to standards such as Universal Plug and Play (UPnP). For example, a user may use a Simple Service Discovery Protocol (SSDP) as a UPnP discovery mechanism to perform “discover device”, and may select and use a desired device (hereinafter, “pairing”).

If there are several devices in a single network, a user should select one of those devices. Information which may be provided by the selected device includes an IP address, a name of the device, etc. Usually, each of the devices in the network have the same name. A user should distinguish the device by using the IP address, which is not easy for an unskilled user.

If a user selects one of the devices by using a remote controller, the selected device should perform a confirmation operation, as to whether to permit an access by the remote controller. The selected device may ask a user for permission/non-permission of the access, and a user should individually respond to a query.

### SUMMARY

Accordingly, one or more exemplary embodiments provide an electronic device, a control device and a control method thereof which enables a user to pair and use network devices without difficulty.

The foregoing and/or other aspects of the exemplary embodiments may be achieved by providing an electronic device including: a first communication unit which is connected to, and communicates with, an other electronic device; a second communication unit which communicates with a control device used to input a user command; and a controller which pairs with the control device for communication, performs an operation based on the user command received from the control device, receives control device information from the control device and transmits the control device information to the other electronic device, and receives electronic device information from the other electronic device and transmits the electronic device information to the control device for communication between the control device and the other electronic device.

The controller may receive the electronic device information from the other electronic device when the other electronic device is connected to the first communication unit.

The controller may transmit information on whether the other electronic device is automatically pairable with the control device.

The controller may pair with the control device based on preset information.

The control device information may include a media access control (MAC) address of the control device.

The electronic device information may include a Universal Unique Identifier (UUID) of an other electronic device.

The foregoing and/or other aspects may be achieved by providing a method of controlling an electronic device, the method including: pairing an electronic device with a control device for communication; performing an operation based on a user command received from the control device; receiving control device information from the control device and transmitting the control device information to an other electronic device for communication between the control device and the other electronic device; receiving electronic device information from the other electronic device, and transmitting the electronic device information to the control device.

The receiving electronic device information may include receiving the electronic device information from the other electronic device when the other electronic device is connected to a first communication unit.

The control method may further include transmitting information on whether the other electronic device is automatically pairable to the control device.

The pairing may include pairing with the control device based on preset information.

The control device information may include a MAC address of the control device.

The electronic device information may include a UUID of an other electronic device.

The foregoing and/or other aspects of the exemplary embodiments may be achieved by providing a control device including: a communication unit which communicates with a first electronic device and a second or other electronic device; an input unit which receives a user command; and a controller which transmits to the first electronic device a user first command by pairing with the first electronic device for communication, the controller transmitting control device information to the first electronic device to be transmitted to the second electronic device, and transmits a second command from a user to the second electronic device by pairing with the second electronic device for communication based on electronic device information of the second electronic device received from the first electronic device.

The controller may automatically pair with the second electronic device in response to a determination that the second electronic device connected to the communication unit corresponds to the electronic device information received from the first electronic device.

The controller may make an inquiry to the first electronic device as to whether the second electronic device is automatically pairable therewith, and receive information of the pairing from the first electronic device.

The control device information may include a MAC address of the control device.

The electronic device information may include a UUID of the second electronic device.

The foregoing and/or other aspects may be achieved by providing a control method of a control device, the control method including: pairing with a first electronic device for communication; transmitting a first command from a user to the first electronic device; transmitting control device information to the first electronic device to be transmitted to a second electronic device; pairing with the second electronic device for communication based on electronic device information of the second electronic device received from the first electronic device; and transmitting a second command from a user to the second electronic device.

The pairing with the second electronic device may include automatically pairing with the second electronic device in response to a determination that the connected second electronic device corresponds to the electronic device information received from the first electronic device.

The control method may further include making an inquiry to the first electronic device about whether the second electronic device is automatically pairable therewith, and receiving information on the pairing from the first electronic device.

The control device information may include a MAC address of the control device.

The electronic device information may include a UUID of the second electronic device.

The foregoing and/or other aspects of the exemplary embodiments may be achieved by providing an electronic device including: a first electronic device having a first communication unit which communicates with an other electronic device; a second communication unit which communicates with a control device which receives a user command; and a controller which transmits electronic device information to the other electronic device, and performs an operation according to the user command received from the control device by pairing with the control device for communication based on control device information of the control device that is received from the other electronic device.

The controller may transmit the electronic device information to the other electronic device when the other electronic device is connected to the first communication unit.

The controller may automatically pair with the control device in response to a determination that the control device connected to the second communication unit corresponds to the control device information received from the other electronic device.

The control device information may include a MAC address of the control device.

The electronic device information may include a UUID of the electronic device.

The foregoing and/or other aspects of the exemplary embodiments may be achieved by providing a method of controlling an electronic device, the method including: transmitting electronic device information to an other electronic device for communication with a control device; pairing with the control device for communication based on control device information of the control device received from the other electronic device; and performing an operation according to a user command received from the control device.

The transmitting the electronic device information may include transmitting the electronic device information to the other electronic device when connected to an other electronic device.

The pairing with the control device may include automatically pairing with the control device in response to a determination that the connected control device corresponds to the control device information received from the other electronic device.

The control device information may include a MAC address of the control device.

The electronic device information may include a UUID of the electronic device.

### BRIEF DESCRIPTION OF THE DRAWINGS

The above and/or other aspects of the exemplary embodiments will become apparent and more readily appreciated from the following description, taken in conjunction with the accompanying drawings, in which:

FIG. 1 illustrates a display apparatus, a remote controller and an image device according to an exemplary embodiment;

FIG. 2 is a block diagram of the display apparatus in FIG. 1;

FIG. 3 is a block diagram of the remote controller in FIG. 1;

FIG. 4 is a block diagram of the image device in FIG. 1; and

FIG. 5 illustrates detailed operations of the display apparatus, the remote controller and the image device of FIGS. 1 to 4.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

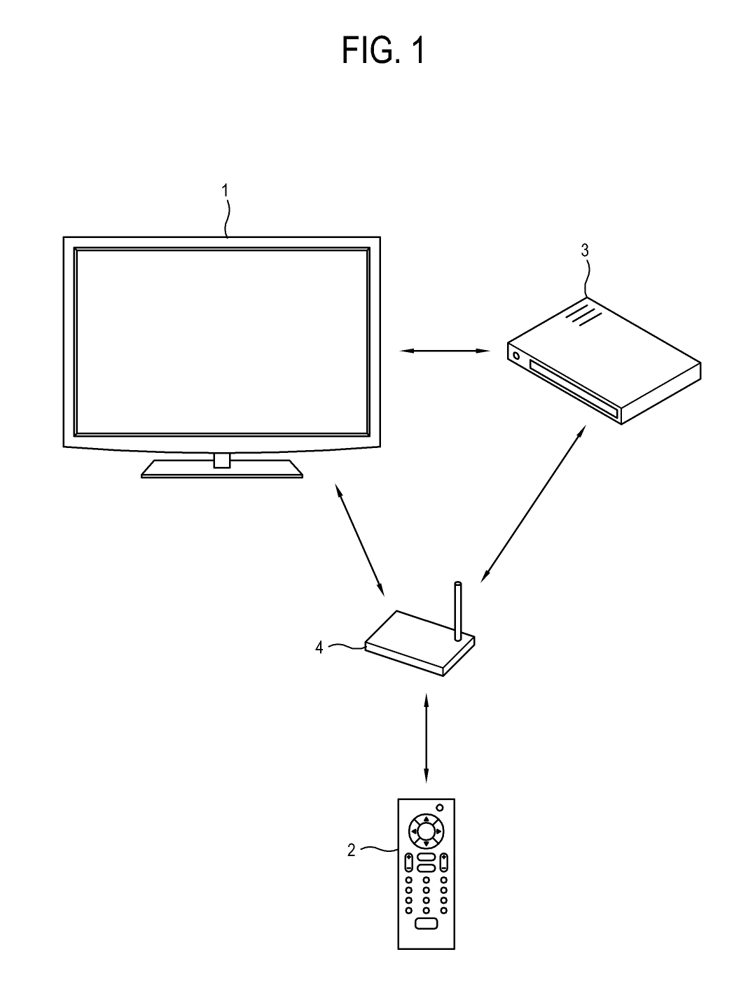

Hereinafter, an exemplary embodiment will be described in detail. FIG. 1 illustrates a display apparatus, a remote controller and an image device according to an exemplary embodiment. A display apparatus 1, a remote controller 2 and an image device 3 are provided as network devices which may communicate with one another through an access point (AP) 4. Network communications performed between display apparatus 1, remote controller 2 and image device 3 may vary and include Ethernet and Wi-Fi. Display apparatus 1, remote controller 2 and image device 3 pair with one another in order for a user to use devices 1 and 3 through the remote controller 2. The device pairing according to the present exemplary embodiment may be performed by using Simple Service Discovery Protocol (SSDP) as a Universal Plug and Play (UPnP) discovery mechanism. Display apparatus 1 and image device 3 are examples of electronic devices according to an exemplary embodiment. Remote controller 2 is an example of a control device according to an exemplary embodiment.

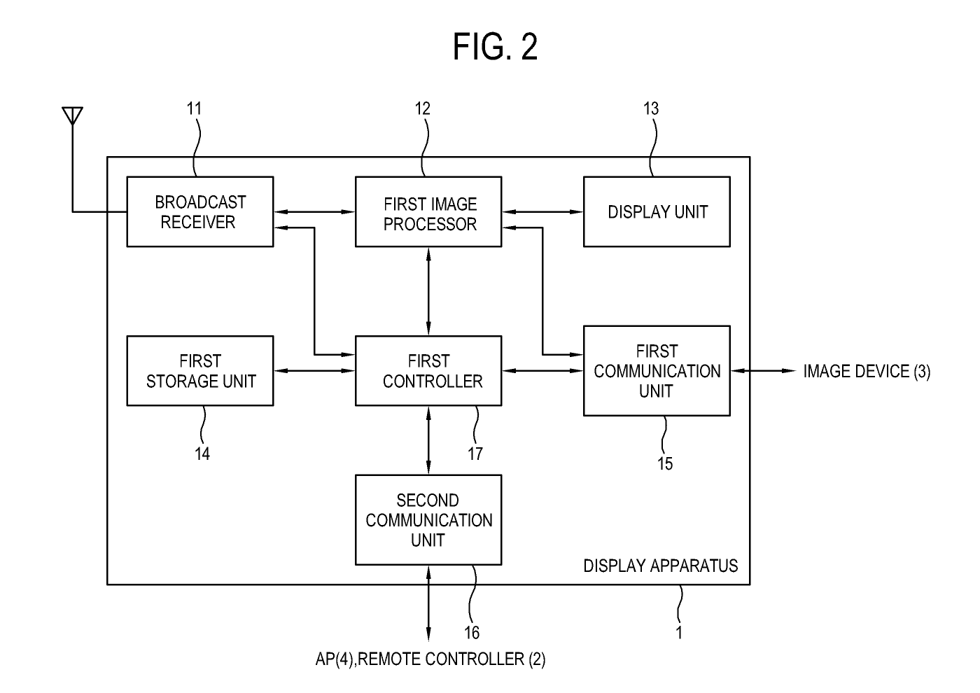

FIG. 2 is a block diagram of display apparatus 1, shown in FIG. 1. Display apparatus 1 may be provided as a TV. Display apparatus 1 may include a broadcasting receiver 11, a first image processor 12, a display unit 13, a first storage unit 14, a first communication unit 15, a second communication unit 16 and a first controller 17.

Broadcasting receiver 11 may receive a broadcast which includes image content. The broadcast signal may include an audio content and/or a data content as well as image content. Broadcast receiver 11 may selectively receive a broadcast signal from one of a plurality of channels. The broadcast signal includes an air-wave broadcast signal, a cable broadcast signal, a satellite broadcast signal and other known broadcast signals that an artisan would be aware of The types of broadcast signals includes digital broadcasting signals and analog broadcasting signals.

First communication unit 15 may communicate with image device 3 which transmits an image signal. The communication method performed by the first communication unit 11 includes High Definition Multimedia Interface (HDMI). First communication unit 15 may include a connector (not shown) corresponding to the communication method, and be connected to a cable (not shown), through which, the first communication unit 15 is connected to image device 3.

First image processor 12 processes a broadcasting signal received by broadcasting receiver 11, and an image signal received by first communication unit 15, and displays the received signals. The image processing performed by first image processor 12 includes demultiplexing, decoding, scaling, picture quality adjustment and picture quality improvement. First image processor 12 may process an image on a user interface (UI) menu, for a user interface. First image processor 12 may overlap an image obtained from an image content and at least a part of a UI menu in a single screen, or arrange the foregoing to be side by side.

Display unit 13 displays thereon an image processed by first image processor 12. The display method of the image by display unit 13 is not limited, and includes all of known display methods. The display method may be provided by using liquid crystal display (LCD), organic light emitting diode (OLED), plasma display panel (PDP), projection, cathode ray tube (CRT), etc.

First storage unit 14 stores therein data for conducting operations of display apparatus 1. First storage unit 14 includes all types of non-volatile memories which are known to store therein data semi-permanently. The non-volatile memory may include an electrically erasable programmable read-only memory (EEPROM), a flash memory, and a hard disk drive (HDD).

Second communication unit 16 communicates with remote controller 3 to receive a remote control signal from remote controller 3.

First controller 17 controls overall operations of display apparatus 1. First controller 17 controls each element of the display apparatus 1 according to a user's input information that has been obtained from a remote control signal received from remote controller 3. First controller 17 may control first broadcasting receiver 11 in order to receive a broadcast signal from a desired channel. First controller 17 may control first image processor 12 to process a broadcast signal received by the broadcast receiver 11 and an image signal received by first communication unit 15. First controller 17 controls both remote controller 2 and image device 3 so they can pair with each other (to be described later). First controller 17 may store data in first storage unit 14 or read data stored in first storage unit 14, when necessary for the foregoing control operation.

First controller 17 may include a non-volatile memory (not shown) which stores therein an execution code of a computer program, which corresponds to the control operation; a volatile memory (not shown) to load at least a part of the execution code stored in the non-volatile memory, and a microprocessor (not shown) to execute the execution code loaded to the volatile memory.

Display apparatus 1 may further include other and/or additional elements for its operation. For example, display apparatus 1 may include an audio signal receiver, an audio signal processor and an audio output unit for receiving, processing and outputting an audio signal, respectively. The audio signal receiver may also provide an input pad unit provided in the display apparatus 1, separate from user input 20, in order to receive a user's input, and a power supply unit for supplying power to operations of display apparatus 1.

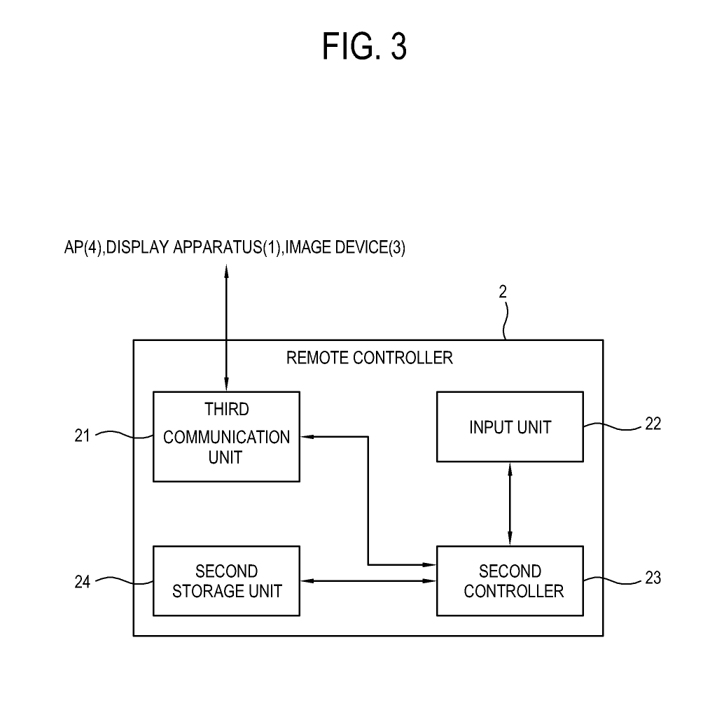

FIG. 3 is a block diagram of the remote controller 2 according to the exemplary embodiment. As shown therein, remote controller 2 may include a third communication unit 21, an input unit 22, a second storage unit 24 and a second controller 23. Input unit 22 may include a key pad including a plurality of keys which correspond to numbers and characters in order to receive a user input, and/or may include a touch pad to detect a user input. Third communication unit 21 communicates with display apparatus 1 and image device 3 through AP 21. Second storage unit 24 stores therein a program and/or data for the operation of remote controller 2. Second controller 23 controls overall operations of remote controller 2. More specifically, second controller 23 transmits a user input, received by the input unit 22, to display apparatus 1 and/or image device 3 through the third communication unit 21, in order to enable a user to use display apparatus 1 and/or image device 3 through the remote controller 2. Second controller 23 controls pairing with image device 3 (to be described later). Remote controller 2 may further include a display means such as a liquid crystal display (LCD) to display thereon an operation status of remote controller 2.

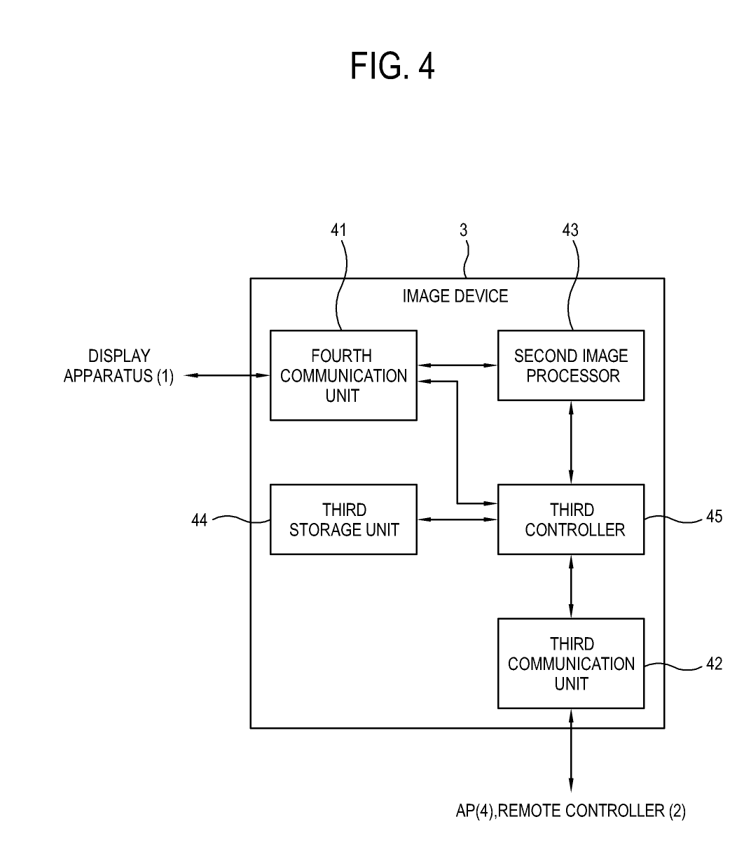

FIG. 4 is a block diagram of image device 3 according to an exemplary embodiment. As shown therein, image device 3 may include a fourth communication unit 41, a fifth communication unit 42, a second image processor 43, a third storage unit 44 and a second controller 45. Image device 3 supplies an image signal to display apparatus 1. Image device 3 may vary and may include a digital versatile disc (DVD) player, a blue-ray disc (BD) player, a PC, a mobile phone, a smart phone, and other TVs. As described above, fourth communication unit 41 communicates with first communication unit 11 of the display apparatus 1 by being connected to a cable (not shown), in order to be connected to display apparatus 1 by the HDMI. Fifth communication unit 51 communicates with third communication unit 21 of remote controller 2 through the AP 4 for the connection to remote controller 2.

Second image processor 43 processes an image signal to be supplied to display apparatus 1. Third storage unit 44 stores therein a program and/or data for operation of image device 3. Third controller 45 controls overall operations of image device 3. Third controller 45 controls pairing with remote controller 2 (to be described later), and performs a control operation according to a user's command received from remote controller 2 when pairing with the remote controller 2 is completed. Image device 3 may further include a medium player which plays a recording medium such as a DVD or a BD storing therein image signal data, and obtains an image signal therefrom.

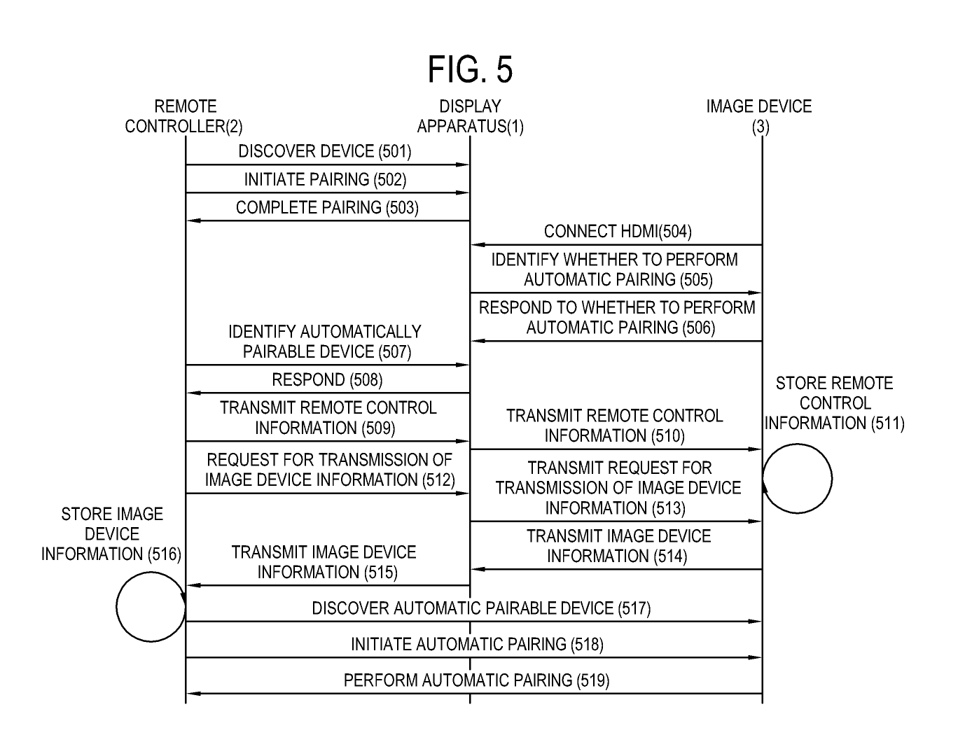

FIG. 5 illustrates detailed operations of the display apparatus 1, remote controller 2 and image device 3, as illustrated in FIGS. 1 to 4. According to the exemplary embodiment, display apparatus 1 and remote controller 2 communicate with each other by Wi-Fi. Display apparatus 1 and image device 2 communicate with each other by HDMI, and remote controller 2 and the image device 3 communicate with each other by Wi-Fi.

At operation 501, remote controller 2 discovers connectable devices. At operation 502, remote controller 2 determines display apparatus 1 to be a connectable device and initiates a pairing with display apparatus 1. At operation 503, display apparatus 1 performs a corresponding operation for the pairing with remote controller 2 and informs remote controller 2 of a completion of the operation. At operations 501 to 503, pairing of display apparatus 1 and remote controller 2 may be automatically performed by predetermined information. More specifically, display apparatus 1 and remote controller 2 may store counterpart's media access control (MAC) address or the like in advance and pair with each other by using the stored information. Pairing of display apparatus 1 and remote controller 2 may be performed when the devices are initially turned on (when initially turned on after purchase; display apparatus 1 and remote controller 2 are presumed to be sold in a package). If the two devices pair with each other, they may freely communicate with each other as a certified device. Accordingly, a user may manipulate display apparatus 1 by using remote controller 2.

Returning to FIG. 5, at operation 504, image device 3 is connected to the display apparatus 1 by, e.g., an HDMI connection. Image device 3 may be connected to display apparatus 1 by a user, through an HDMI cable. At operation 505, display apparatus 1 identifies a “profile” of the paired device. That is, whether image device 2 may automatically pair with display apparatus 1 (hereinafter, “automatic pairing”). Image device 3 according to the present exemplary embodiment is presumed to be automatically pairable. At operation 506, when display apparatus 1 makes an inquiry regarding automatic pairing, image device 3 responds to display apparatus 1, and informs display apparatus 1 that it may perform the automatic pairing. If image device 3 is connected to display apparatus 1, an image signal may be transmitted from image device 3 to display apparatus 1. Display apparatus 1 may display an image based on the image signal received from image device 3.

Referring to FIG. 5, at operation 507, remote controller 2 makes an inquiry about the presence of a device capable of performing the automatic pairing as a device identified by display apparatus 1. Upon receiving the inquiry from the remote controller 2 about the presence of the device capable of performing the automatic pairing at operation 508, display apparatus 1 informs remote controller 2 of the presence of image device 3, which is capable of the automatic pairing. At operation 509, if the presence of image device 3, which is capable of automatic pairing, is identified, remote controller 2 transmits to display apparatus 1 its information for the automatic pairing with image device 3 (hereinafter, “remote control information”). The remote control information according to the present exemplary embodiment includes a MAC address of the remote controller 2 which is used for a UPnP access control. At operation 510, display apparatus 1 transmits to image device 3 the remote control information received from remote controller 2. At operation 511, image device 3 stores the remote control information transmitted by display apparatus 1.

At operation 512, remote controller 2 requests the transmission of information from image device 3 (hereinafter “image device information”) for the automatic pairing with image device 3. At operation 513, display apparatus 1 transmits to image device 3 the request for transmission of the image device information of remote controller 2, that was received by display apparatus 1, from remote controller 2. At operation 514, image device 3 transmits its image device information to display apparatus 1 in response to the request for transmission of the image device information of remote controller 2.

The image device information, according to the exemplary embodiment, includes a Universal Unique Identifier (UUID) of the image device 3 as UPnP server information for remote controller 2 to automatically discover device 3, in the UPnP network. At operation 515, display apparatus 1 transmits to the remote controller 2 the image device information transmitted by image device 3. At operation 516, remote controller 2 stores the image device information of image device 3 transmitted by display apparatus 1. After operation 516, image device 3 may set a network on its own in order to pair with remote controller 2.

Returning to FIG. 5, if image device 3 is connected in the network, remote controller 2 automatically discovers the UPnP device at operation 517. At operation 518, remote controller 2 initiates the automatic pairing with image device 3 by using the stored image device information of image device 3. That is, if the discovered UUID of the UPnP server device is the same as that of image device 3, remote controller 2 immediately initiates the pairing with image device 3, even without user confirmation.

At operation 519, image device 3 performs automatic pairing with remote controller 2 by using the stored remote control information of remote controller 2, and informs remote controller 2 of the foregoing. If the MAC address of the device requesting the pairing is the same as the stored information of remote controller 2, image device 3 automatically permits subscription without any additional permission process by the user. When pairing of remote controller 2 and image device 3 is completed, a user may freely manipulate image device 3 by using remote controller 2.

According to the exemplary embodiment, the remote controller and the image device automatically pair with each other without a user intervention by using the display apparatus and the remote controller which have already paired with each other, to enable a user to conveniently and easily use the devices.

The present invention has been described in detail according to the preferable foregoing exemplary embodiments, but not limited thereto. For example, the electronic device according to the exemplary embodiments includes the display apparatus 1 and the image device 3 only, but may further include other various devices having a network communication function. Likewise, the control device according to the exemplary embodiments is not limited to remote controller 2 of the display apparatus and may further include other various devices controlling other electronic devices according to a user command.

Control device 2 pairs with a single image device 3 according to the exemplary embodiments, but not limited thereto. Alternatively, the control device may pair with a plurality of electronic devices, and the control device may pair with other several electronic devices by using one of the electronic devices pairing with the control device.

As described above, an electronic device, a control device and a control method thereof according to an exemplary embodiment enables a user to pair network devices without difficulty.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A device comprising:
An electronic device including a first communication unit which is connected to, and communicates with, an other electronic device;
a second communication unit which communicates with a control device, wherein the control device is used to input a user command; and
the electronic device includes a controller which pairs with the control device for communication, and performs an operation based on the user command received from the control device, the controller receives control device information from the control device and transmits the control device information to the other electronic device, the controller receives electronic device information from the other electronic device and transmits the electronic device information to the control device for communication between the control device and the other electronic device.

2. The device according to claim 1, wherein the controller receives the electronic device information from the other electronic device when the other electronic device is connected to the first communication unit.

3. The device according to claim 1, wherein the controller transmits to the control device information regarding whether the other electronic device is automatically pairable with the control device.

4. The device according to claim 1, wherein the controller pairs with the control device based on preset information.

5. The device according to claim 1, wherein the control device information comprises a media access control address of the control device.

6. The device according to claim 1, wherein the electronic device information comprises a universal unique identifier of an other electronic device.

7. A method of controlling an electronic device, the method comprising:
pairing a controller of the electronic device with a control device for communication;
performing an operation based on a user command received from the control device;
receiving control device information from the control device and transmitting the control device information to an other electronic device for a communication between the control device and the other electronic device; and
receiving electronic device information from the other electronic device and transmitting the received electronic device information to the control device.

8. The method according to claim 7, wherein the received electronic device information comprises receiving the electronic device information from the other electronic device when the other electronic device is connected to a first communication unit.

9. The method according to claim 7, further comprising transmitting information on whether the other electronic device is automatically pairable to the control device.

10. The method according to claim 7, wherein the pairing comprises pairing the controller of the electronic device with the control device based on preset information.

11. The method according to claim 7, wherein the control device information comprises a media access control address of the control device.

12. The method according to claim 7, wherein the electronic device information comprises a universal unique identifier of the other electronic device.

13. A control device comprising:
a communication unit which communicates with a first electronic device and a second electronic device;
an input unit which receives a user command; and
a controller which transmits to the first electronic device a first user command by pairing with the first electronic device for communication, the controller transmits control device information to the first electronic device to be transmitted to the second electronic device, and transmits a second user command to the second electronic device by pairing with the second electronic device for communication based on electronic device information of the second electronic device which is received from the first electronic device.

14. The control device according to claim 13, wherein the controller automatically pairs with the second electronic device in response to a determination that the second electronic device connected to the communication unit corresponds to the electronic device information received from the first electronic device.

15. The control device according to claim 13, wherein the controller makes an inquiry to the first electronic device as to whether the second electronic device is automatically pairable therewith, and receives information regarding a pairing from the first electronic device.

16. The control device according to claim 13, wherein the control device information comprises a media access control address of the control device.

17. The control device according to claim 13, wherein the electronic device information comprises a universal unique identifier of the second electronic device.

18. A method of controlling a control device, the method comprising:
pairing a controller with a first electronic device for communication;
transmitting a first user command to the first electronic device;
transmitting control device information to the first electronic device, for transmission to the second electronic device;
pairing the controller with the second electronic device for communication based on electronic device information of the second electronic device received from the first electronic device; and
transmitting a second user command to the second electronic device.

19. The method according to claim 18, wherein the pairing with the second electronic device comprises automatically pairing with the second electronic device in response to a determination that the connected second electronic device corresponds to the electronic device information received from the first electronic device.

20. The method according to claim 18, further comprising making an inquiry to the first electronic device regarding whether the second electronic device is automatically pairable therewith, and receiving information regarding a pairing from the first electronic device.

21. The method according to claim 18, wherein the control device information comprises a media access control address of the control device.

22. The method according to claim 18, wherein the electronic device information comprises a universal unique identifier of the second electronic device.

23. A device comprising:
an electronic device having a first communication unit which communicates with an other electronic device;
a second communication unit which communicates with a control device to receive a user command; and
a controller which transmits electronic device information to the other electronic device, the controller performing an operation according to the user command received from the control device by pairing the controller with the control device for communication based on control device information of the control device which is received from the other electronic device.

24. The device according to claim 23, wherein the controller transmits the electronic device information to the other electronic device when the other electronic device is connected to the first communication unit.

25. The device according to claim 23, wherein the controller automatically pairs with the control device in response to a determination that the control device connected to the second communication unit corresponds to the control device information received from the other electronic device.

26. The device according to claim 23, wherein the control device information comprises a media access control address of the control device.

27. The device according to claim 23, wherein the electronic device information comprises a universal unique identifier of the electronic device.

28. A method of controlling an electronic device, the method comprising:
transmitting electronic device information to an other electronic device for communication with a control device;
pairing the electronic device with the control device for communication based on control device information of the control device received from the other electronic device; and
performing an operation according to a user command received from the control device.

29. The method according to claim 28, wherein the transmitting of the electronic device information comprises transmitting the electronic device information to the other electronic device when connected to the other electronic device.

30. The method according to claim 28, wherein the pairing with the control device comprises automatically pairing with the control device in response to a determination that the connected control device corresponds to the control device information received from the other electronic device.

31. The method according to claim 28, wherein the control device information comprises a media access control address of the control device.

32. The method according to claim 28, wherein the electronic device information comprises a universal unique identifier of the electronic device.
